(19) United States
(12) Patent Application Publication
(10) Pub. No.: US 2007/0186187 A1
(43) Pub. Date: Aug. 9, 2007

(54) Scoring mechanism with visual communication of more than one reading

(75) Inventors: Jeannine A. Strope, Longmont, CO (US); Larry L. Constantine, Rowley, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Information Solutions LLC

(21) Appl. No.: 11/349,703

(22) Filed: Feb. 8, 2006

(51) Int. Cl. G06F 19/00

(52) U.S. Cl. 715/833; 700/92

(57) ABSTRACT

An electronic progress scoring mechanism or indicator visually informs the user of how much of a task is complete and what is the nature or direction of the progress of task completion (positive or negative). A goal scoring software provides a scale and indicator based display for a task whose progress is to be monitored. The indicator can slide over the scale to indicate the most recent status of the task. A bi-directional reference pointer is displayed adjacent to the scale to provide a visual cue as to whether the most recent status indicates an upward (e.g. “better”) or downward (e.g. “worse”) progress from the immediately preceding status. An overlayed display window may also be provided adjacent to the sliding indicator to textually display the two most recent scores of progress and the relationship between them (i.e., whether there is a positive or negative movement from an earlier score to the most recent score). The task status indicator display can provide significantly more information on the progress of a task in an intuitive, but non-intrusive (non-distracting) manner. Because of the rules governing abstracts, this abstract should not be used to construe the claims.

### BACKGROUND

1. Field of the Disclosure

The present disclosure generally relates to electronic displays of text and other information, and, more particularly, to an electronic scoring mechanism with visual communication of the scoring movement on a scale.

2. Brief Description of Related Art

There have been many approaches to display progress of an activity, task, or operation on an electronic display (e.g., a computer monitor). In one approach, a computer's operating system may use a graphical user interface (GUI) to indicate the progress of task by displaying a wristwatch icon as shown in FIG. 1A. In an alternative approach, an hourglass icon may be displayed as illustrated in FIG. 1B. In another approach, a clock icon as shown in FIG. 1C may be displayed. In different other approaches, the clock may be represented as an analog clock or a digital clock with an indication of the time remaining to complete the activity (e.g., a stopwatch, counter, or similar timer mechanism). These icons are typically used when a task will take a short time to complete. Furthermore, these icons are often static; that is, they do not change shape or appearance while the task is in progress, although some operating systems or user applications allow them to change shape to indicate that the task is still underway. For example, the wristwatch and clock icons of FIGS. 1A and 1C may show one of the hands (e.g., the second hand) moving, and the hourglass of FIG. 1B may be occasionally filled and rotated (inverted), during the task duration. Nevertheless, these icons do not indicate the progress of the task, i.e., how much of the task is completed but, rather, only indicate that the task is still active.

For tasks estimated to be of long duration, a progress window is often painted on the computer screen. This indicator typically takes the form of a rectangular horizontal bar that is displayed to indicate the progress of an operation (e.g., progress of a software download or installation operation). The horizontal bar automatically fills in (with a pre-selected color) from left-to-right in proportion to the amount of the task completed as illustrated in FIG. 2 and as is known in the art.

The first form of a task status indicator (FIGS. 1A-1C) is uninformative; the only information the user can perceive about task duration is that it will be less than the amount that the programmer deemed appropriate for use of the second indicator type (FIG. 2). That is, all the user knows is that the wait time will be “short.” It may be inappropriate to use the second form of progress indicator (FIG. 2) for shorter tasks because the visual impact of window creation and deletion may be distracting. Also, the computer processor resources consumed by window creation, updating, and deletion may actually be significant relative to the duration of the task itself. The inherently minimal (or almost non-existent) informational content in the prior art task status indicators may render these indicators unsuitable for monitoring progress of various complex and long term activities (e.g., a patient's condition, a process parameter, etc.).

Therefore, it is desirable to provide a task status indicator that can provide significantly more information on the progress of the task than the prior art display mechanisms illustrated in FIGS. 1-2. It is further desirable to provide an electronic progress scoring mechanism or indicator that visually informs the user of how much of a task is complete and what is the nature or direction of the progress of task completion (positive or negative). It is further desirable for this indicator to provide information on the task progress in an intuitive but non-intrusive (non-distracting) manner.

### SUMMARY

The present disclosure contemplates an electronic display, which comprises a scale icon and an indicator positioned on the scale icon to indicate a most recent score for a task associated with the scale icon. The electronic display also comprises a reference pointer displayed proximate to the scale icon to provide a visual cue as to whether the most recent score is an upward (increase) or downward (decrease) movement from a previous score for the task. The present disclosure also contemplates hardware (including a computer display terminal) and appropriate software (including a storage medium for the software) to generate and view these contents of the electronic display.

In another embodiment, the present disclosure contemplates an electronic display, which comprises a scale icon and an indicator positioned on the scale icon at a first location to indicate a most recent score for a task associated with the scale icon. The electronic display further comprises a display window positioned in an overlayed format adjacent to the indicator to provide a textual display of at least one of the following: the first score associated with the first location; a second score associated with a second location of the indicator for a score immediately preceding the most recent score; and an indication of whether the first score is an increase or decrease from the second score. The present disclosure also contemplates hardware (including a computer display terminal) and appropriate software (including a storage medium for the software) to generate and view these contents of the electronic display.

In an alternative embodiment, the present disclosure contemplates a task status monitor to observe the progress of a task on an electronic display. The monitor comprises means for displaying a scale icon and means for displaying an indicator positioned on the scale icon to indicate a most recent score for a task associated with the scale icon. The monitor also comprises means for displaying a reference pointer proximate to the scale icon to provide a visual cue as to whether the most recent score is an upward (increase) or downward (decrease) movement from a previous score for the task. In one embodiment, the task status monitor further comprises means for displaying a window positioned in an overlayed format proximate to the indicator to provide a textual display of at least one of the following: a first score associated with a first location of the indicator along the scale icon to indicate the most recent score; a second score associated with a second location of the indicator to indicate the previous score, wherein the previous score immediately precedes the most recent score; and an indication of whether the first score is an increase or decrease from the second score.

In one embodiment, the present disclosure contemplates a method that comprises receiving information related to a progress of a task and providing an electronic display of the progress of the task on a first computer monitor associated with a first computer. The scale icon and indicator based electronic display may contain the items mentioned hereinabove. The method also contemplates sending contents of the electronic display to a second computer over a communication network (e.g., the Internet) to be displayed in a form that is substantially similar to the electronic display on a second computer monitor associated with the second computer. The present disclosures also contemplates a communication network-based system including a host computer and a client computer to implement this method of sharing the electronic display between the network-linked host and client computers.

The present disclosure is thus related to an electronic progress scoring mechanism or indicator that visually informs the user of how much of a task is complete and what is the nature or direction of the progress of task completion (positive or negative). A goal scoring software provides a scale icon and indicator based display for a task whose progress is to be monitored. The indicator can slide over the scale icon to indicate the most recent status of the task. A bi-directional reference pointer is displayed adjacent to the scale icon to provide a visual cue as to whether the most recent status indicates an upward (“better” or “more desirable”) or downward (“worse” or “less desirable”) progress from the immediately preceding status. An overlayed display window may also be provided adjacent to the sliding indicator to textually display the two most recent scores of progress and the relationship between them (i.e., whether there is a positive or negative movement from an earlier score to the most recent score). The task status indicator display can provide significantly more information on the progress of a task in an intuitive, but non-intrusive (non-distracting) manner.

### BRIEF DESCRIPTION OF THE DRAWINGS

For the present disclosure to be easily understood and readily practiced, the present disclosure will now be described for purposes of illustration and not limitation, in connection with the following figures, wherein:

FIGS. 1A-1C are depictions of task status indicators as used in prior art graphical user interfaces;

FIG. 2 is an illustration of an informational window that is used in prior art computer systems to indicate the progress of a task;

FIG. 3 illustrates a generalized operational flow for a goal scoring software according to one embodiment of the present disclosure;

FIG. 4 depicts an exemplary setup to utilize the goal scoring software according to one embodiment of the present disclosure;

FIG. 5 is a simplified flowchart depicting operation of the goal scoring software according to one embodiment of the present disclosure;

FIG. 6 illustrates an exemplary screenshot depicting a reference pointer-based task progress monitor display according to one embodiment of the present disclosure;

FIG. 7 shows the screenshot of FIG. 6 with a task-specific overlayed window displaying textual information about the most recent progress status for the task;

FIG. 8 depicts another screenshot of FIG. 6 with a different content in the task-specific overlayed window shown in FIG. 7; and

FIG. 9 illustrates an exemplary screenshot that partially depicts scale and indicator based electronic score displays for a patient's plan of care in a hospital environment.

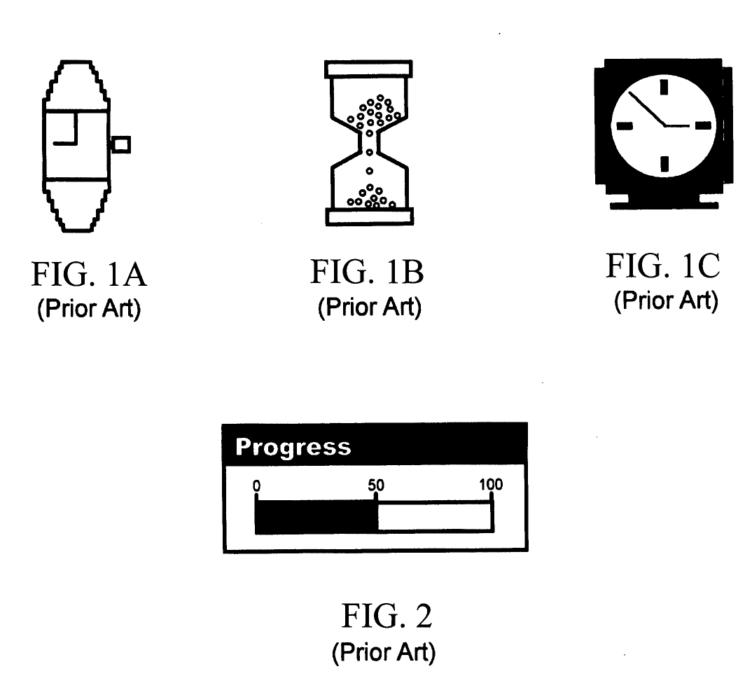

### DETAILED DESCRIPTION

Reference will now be made in detail to certain embodiments of the present disclosure, examples of which are illustrated in the accompanying drawings. It is to be understood that the figures and descriptions of the present disclosure included herein illustrate and describe elements that are of particular relevance to the present disclosure, while eliminating, for the sake of clarity, other elements found in typical electronic content display devices or systems and software. It is noted at the outset that the terms “goal scorer”, “task progress monitor,” or “task status indicator” as used herein are used in their broadest sense to refer to task status or progress monitoring with any form of underlying electronic data input: text, numbers, symbols, graphics, or any other data format. Thus, the term “data,” as used hereinbelow, may refer to an electronic content in any form-text, symbol, graphics, etc. Furthermore, the term “task” is used broadly hereinbelow to include any activity, operation, process, action, data input, etc., whose status indication is performed according to the teachings of the present disclosure.

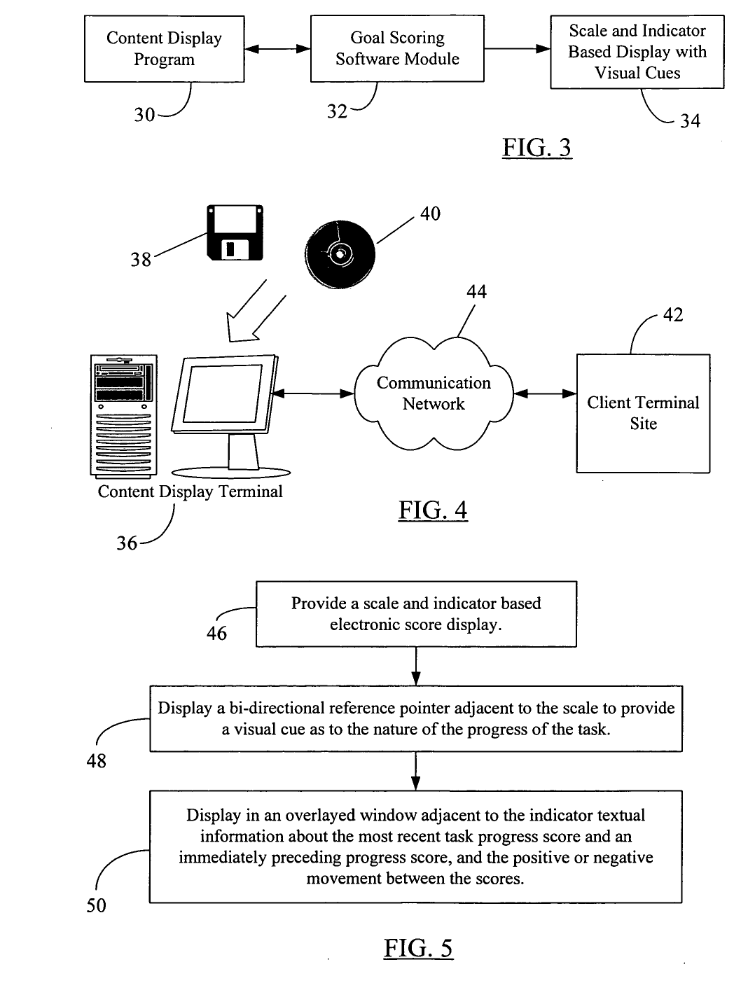

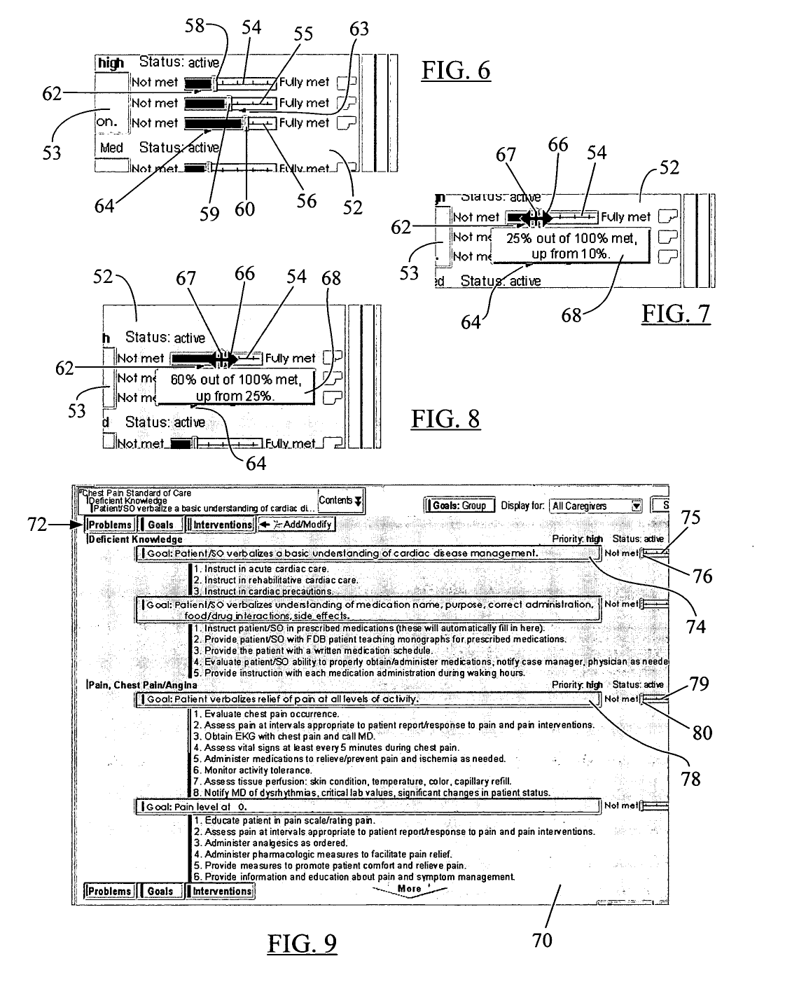

FIG. 3 illustrates a generalized operational flow for a goal scoring software module or “goal scorer” according to one embodiment of the present disclosure. The goal scorer is represented by the block 32 and, as discussed later hereinbelow, may be used to display on an electronic video terminal or display unit (e.g., a computer screen or monitor) the score or progress of a task or goal to be accomplished. It is observed here that the term “score”, as used hereinbelow, broadly refers to a variety of numerical or non-numerical (e.g., textual) information including, for example, a percentage progress of a task or event or activity with reference to the final desired level of completion (as shown, for example, in the embodiments of FIGS. 7-8), or a unitary or stand-alone parameter (e.g., a temperature reading in a power plant) associated with a task (e.g., the task of monitoring temperature readings in a power plant) whose progress is to be monitored, etc. Even though the goal scorer according to one embodiment of the present disclosure may contain a number of program modules or program code blocks, for simplicity and ease of discussion, the reference numeral “32” is used hereinbelow to refer to the goal scoring software module designed to implement the teachings according to one embodiment of the present disclosure. In one embodiment, the goal scorer 32 may interact with a content display program (block 30, FIG. 3) to link the goal scoring or goal progress monitoring with appropriate content displayed by the content display program 30. In one embodiment, the content display program may provide numerical values for various positions of the progress status indicator displayed by the goal scorer 32 and may also store the complete progress report for the task or goal to be monitored as discussed later hereinbelow. The goal scorer 32, operating in conjunction with the content display program 30, may provide a scale and indicator based display (block 34, FIG. 3) (discussed later hereinbelow with reference to FIGS. 6-9) with visual cues as to the nature of the progress of the task or goal to be accomplished as discussed below. In another embodiment, the goal scorer 32 may provide the display functionality without interacting with the content display program 30.

FIG. 4 depicts an exemplary setup to utilize the goal scoring software 32 according to one embodiment of the present disclosure. A content display terminal or computer 36 may execute or “run” the goal scoring program application 32 either automatically (e.g., along with the content display program 30 whenever the content display program 30 is executed) or when instructed by a user (e.g., a nurse or other patient administrator in case of a hospital setting). Upon execution of the goal scoring program 32, the progress of a task to be monitored may be displayed on the computer terminal or monitor display screen of the content display terminal 36 in the manner discussed hereinbelow with reference to FIGS. 5-9. The program code for the goal scorer application 32 may be stored on a portable data storage medium, e.g., a floppy diskette 38, a compact disc 40, a data cartridge tape (not shown) or any other, portable or non-portable, magnetic, solid state, or optical data storage medium. The goal scoring application 32 will likely be a module available to a much larger program (e.g., the content display program 30).

The content display terminal 36 may include appropriate disk drives to receive the portable data storage medium and to read the program code stored thereon, thereby facilitating execution of the goal scoring software 32. In one embodiment, the goal scorer program 32 may directly reside on a hard drive (not shown) of the display terminal 36. The goal scoring software 32, upon execution by a processor of the computer 36, may cause the computer 36 to perform a variety of data processing and display tasks including, for example: retrieval of relevant data to be displayed; arrangement, organization and display of the data in the manner discussed hereinbelow with reference to FIG. 5; changing the content to be displayed when indicated by a user (e.g., using a computer keypad, mouse, or similar instruction input device); transmission of the displayed content and its format of display to a remote computer site 42 (discussed in more detail hereinbelow), etc.

As illustrated in FIG. 4, in one embodiment, the content display terminal 36 may be remotely accessible from a client terminal site 42 via a communication network 44. In one embodiment, the communication network 44 may be an Ethernet LAN (local area network) connecting all the computers or data processing units within a facility, e.g., a university research laboratory, a corporate data processing center, a manufacturing plant, a hospital, etc. In that case, the content display terminal 36 and the client terminal 42 may be physically located at the same site, e.g., a university research laboratory or a hospital. In alternative embodiments, the communication network 44 may include, independently or in combination, any of the present or future wireline or wireless data communication networks, e.g., the Internet, the PSTN (public switched telephone network), a cellular telephone network, a WAN (wide area network), a satellite-based communication link, a MAN (metropolitan area network), etc.

The content display terminal 36 may be, e.g., a personal computer (PC), a laptop computer, a workstation, a minicomputer, a mainframe, a handheld computer, a small computing device, a graphics workstation, or a computer chip embedded as part of a machine or mechanism (e.g., a computer chip embedded in a tablet PC or an electronic display, etc.). Similarly, the terminal (not shown) at the remote client site 42 may also be capable of viewing and manipulating (e.g., editing) the contents transmitted to it by the content display terminal 36. In one embodiment, the client terminal site 42 may also include the content display terminal 36, which can function as a server computer and can be accessed by other computers at the client site 42 via a LAN. Each computer—the display terminal 36 and the remote computer or other electronic display terminal (not shown) at the client site 42—may include requisite data storage capability (to store, for example, the data to be displayed) in the form of one or more volatile and non-volatile memory modules. The memory modules may include RAM (random access memory), ROM (read only memory) and HDD (hard disk drive) storage. In one embodiment, the goal scorer 32 may also reside on a computer terminal (not shown) at the remote site 42. In that case, the task progress may be monitored locally at the client site 42 without accessing the “central” or “primary” processing unit 36.

FIG. 5 is a simplified flowchart depicting operation of the goal scoring program 32 according to one embodiment of the present disclosure. Initially, without any external input (e.g., input from a user or from an automated process or software), the goal scoring software 32 may provide a scale and indicator based electronic score display (illustrated in exemplary FIGS. 6-9 and discussed later hereinbelow) for a task whose progress is to be monitored (block 46, FIG. 5). In one embodiment, the placement of the scale and indicator on the electronic display (e.g., a computer monitor) may be pre-determined by the designer of the goal scorer software 32. For example, the scale may appear on the display adjacent to the display of the content related to the task whose progress is to be monitored. In that case, the position of the scale may be fixed or static on the display screen. Some exemplary embodiments of such a scheme are illustrated in FIGS. 6-9 and discussed later hereinbelow. In an alternative embodiment, a user may “drag” the scale to a desired location in an application window (not shown) on the computer screen. The description or other data content for the task to be monitored may reside in a data storage portion or memory of the display unit 36 that may be separate from the memory unit or data storage portion containing the program code of the goal scoring software 32, and that data content and its display may be handled by the content display program 30 according to one embodiment of the present disclosure. In one embodiment, the content display program 30 may communicate with the goal scorer 32 to “instruct” the scorer software 32 to provide the scale-indicator display for the task data content being displayed by the content display software 30. In another embodiment, a “supervisor” program (e.g., an operating system or other software utility with similar functionality) may monitor execution of both of the programs 30, 32 to synchronize displays of relevant fields on the computer screen. The display of task-related data by the content display program 30 may be automatic (e.g., when monitoring temperature readings in a power plant) or under user control (e.g., a nurse-initiated display of a patient's medical plan of care). However, the display functionality of the goal scorer 32 may be automatically triggered every time the corresponding task-related data are being displayed by the content display program 30.

It is observed here that the scale may be displayed in any orientation (e.g., horizontal, vertical, diagonal, etc.) on the display screen so long as the information conveyed thereby remains intelligible to its user or observer. In the exemplary embodiments of FIGS. 6-9, a horizontal placement of task-related data and associated progress scales is preferred to maintain the context of display and intelligibility of the information conveyed by the display.

As shown at block 48, when the goal scorer 32 receives an external input adjusting the indicator on the scale to a position different from the initial (or “starting”) position at block 46, the goal scorer 32 may also display a bidirectional reference pointer (shown and discussed later hereinbelow with reference to FIGS. 6-8) adjacent to the scale at a location predetermined by the designer of the scorer software 32. Thus, according to one embodiment, although the orientation of the scale may be changeable, the position and orientation of the reference pointer with respect to the location of the scale on the display screen may be fixed. The reference pointer, as discussed later hereinbelow, may provide a visual cue as to the nature of the progress of the task (e.g., whether the task is progressing towards or away from completion) whenever the indicator is moved from one location to another along the scale. The visual cue is provided through the direction of orientation of the reference pointer as discussed later hereinbelow.

In one embodiment, in addition to the reference pointer, the task progress monitor 32 may be configured to display an overlayed or “hovering” window adjacent to the indicator on the scale as mentioned at block 50 in FIG. 5 and discussed later hereinbelow with reference to FIGS. 7-8. The displayed window may include textual information about the most recent task progress score and an immediately preceding progress score, and the positive or negative movement between these two scores as shown, for example, in the embodiments of FIGS. 7-8 and discussed below. In one embodiment, the task status indicator software 32 may be configured to display only the overlayed window of block 50, without displaying the bi-directional reference pointer of block 48. Alternatively, in another embodiment, the goal scoring software 32 may just display the reference pointers of block 48, without displaying the hovering window of block 50. Furthermore, it is observed that in one embodiment the order of display of the reference pointer and the hovering window may be immaterial. That is, the occurrence of displays associated with blocks 48 and 50 in FIG. 5 may not necessarily be in that order. For example, in one embodiment, the task status indicator 32 may be configured to display the overlayed window first before the reference pointer in the context of a specific display. Various other display arrangements or sequence may be devised as desired by one skilled in the art.

FIG. 6 illustrates an exemplary screenshot depicting a reference pointer-based task progress monitor display according to one embodiment of the present disclosure. It is seen from FIG. 6 that the screenshot primarily displays a scale icon and indicator based scoring mechanism obtained from the goal scoring software 32 according to one embodiment of the present disclosure to provide a close-up view of the display without any distracting details. Thus, in FIG. 6, an active workplace window 52 (on a computer screen) is shown to include a task-related portion or window 53 to display various task-related data (not shown). Along with the task data window 53, a number of task progress monitors 54-56 are shown in the form of rectangular marked scales. In one embodiment, each task progress monitor 54-56 may be associated with its corresponding task-related data entry (not shown) in the window 53 as illustrated, for example, in detail in the embodiment of FIG. 9 (discussed later hereinbelow). In the embodiment of FIG. 6, one end of each scale is marked with a starting status for a task (e.g., the “Not Met” status in FIG. 6) and the other end is marked with the desired task completion level or status (e.g., the “Fully Met” level in FIG. 6) to illustrate a line of progress or advancement for task completion or monitoring. Each scale 54-56 has an associated slider mechanism or indicator 58-60, respectively, displayed as a raised, rectangular “button” on the respective scale 54-56. As is known to one skilled in the art, the geometric configuration of the scales 54-56 or the slider bars 58-60 may not have to be rectangular or rectilinear, but can be changed as desired without departing from the teachings of the present disclosure. For example, in one embodiment, the indicators 58-60 may be in a square button form, whereas each of the scales 54-56 may be depicted as a straight line, unidirectional arrow with the arrowhead pointing to the task completion level (e.g., the “Fully Met” level in FIG. 6). Similarly, the visual representation of a scale 54-56 or indicator 58-60 may be changed as desired. For example, in one embodiment, the scales 54-56 may not contain marker lines, and the sliders 58-60 may be circular in shape and colored with specific colors assigned to each different slider. Other display arrangements may also be devised by one skilled in the art.

In the embodiment of FIG. 6, a bi-directional reference pointer 62-64 is shown displayed adjacent to its corresponding scale icon 54-56. In the embodiment of FIG. 6, each of the pointers 62-64 is in the form of an arrowhead ( [symbol] or [symbol] ), however different geometrical forms and representations for the reference pointers may be conceived depending on the application. For example, in one embodiment, the reference pointer may be displayed in the form of a bi-directional vertical arrow (⇑ or ⇓) or vertical arrowhead (▴ or ▾) (instead of a horizontal arrowhead as in the embodiment of FIG. 6) when, for example, the temperature readings in a power plant are being monitored. At any given instance, the arrow may be pointed in only one of the two available directions—either up or down—depending on whether the most recent temperature reading is higher or lower than its immediately previous reading. In case of the temperature reading task, in one embodiment, a reference pointer may be in the form of a colored bar that changes its color, for example, from green to yellow to orange to red, for each increase in the temperature reading. In the embodiment of FIG. 6, the pointers 62-64 may be displayed by the task progress monitor software 32 in one color when the pointer arrowhead is pointing in a particular direction, and in a different color when the arrowhead is pointed in the opposite direction. For example, the pointers 62 and 64 may be displayed in the green color (for rightward or “positive” movement of their corresponding indicators 58, 60), whereas the pointer 63 may be displayed in the red color (for leftward or “negative” movement of its corresponding indicator 59). Similar color schemes may be devised for other pointer configurations and representations as noted hereinbefore.

It is observed here that in one embodiment the reference pointer 62-64 may not be displayed initially (as shown, for example, in the embodiment of FIG. 9), i.e., before the process of task progress monitoring has begun. Without any external input (e.g., from a user or from another software) as to the location to which the slider bar 58-60 is to be moved, there may not be a need to indicate the slider bar direction of movement through reference pointers 62-64. Once a user, for example, moves the indicator 58-60 along the respective scale 54-56, the goal scorer software 32 may “receive” and “interpret” this user input to display appropriate reference pointers 62-64. For example, if an indicator is moving towards or closer to the desired progress level (e.g., the “Fully Met” status in FIG. 6), the goal scorer software 32 may “interpret” this rightward movement as a “positive” movement requiring a rightward pointing reference pointer (e.g., the pointer 62). On the other hand, if an indicator is moving away from the desired progress level (e.g., towards the “Not Met” level in FIG. 6), the goal scorer 32 may “interpret” this leftward movement as a “negative” movement requiring a leftward pointing reference pointer (e.g., the pointer 63). Thus, at a given instance, a reference pointer may assume only one of the two available directions—leftward pointing or rightward pointing—in the embodiment of FIG. 6. That is, although a bi-directional reference pointer is capable to point in any one of the two directions, the goal scoring software 32 may display it in only one direction at any given instance to represent the nature of the progress of the task. The pointers may also have different colors in different directions as already discussed hereinbefore.

After the first rightward sliding of the slider bars 58-60, each of the corresponding reference pointers 62-64 may be displayed with their arrowheads pointed in the direction of the “Fully Met” status. Thereafter, the reference pointers 62-64 may change the direction of their arrowheads depending on whether the movement of the corresponding indicators 58-60 is towards or away from the desired, final status for the task (e.g., the “Fully Met” level in FIG. 6). In the embodiment of FIG. 6, the reference pointers 62-64 are displayed adjacent to that location on the corresponding scale 54-56 where the respective indicators 58-60 were positioned immediately prior to the present, most-recent sliding of the indicators. Thus, for example, with reference to the indicator 58 in FIG. 6, it is seen that the reference pointer 62 is displayed at a location (adjacent to the scale 54) that is prior to the most recent location (i.e., the location shown in FIG. 6) of the indicator 58. The location of the reference pointer 62 signifies that location where the indicator 58 was positioned immediately prior to its most recent placement at the location shown in FIG. 6. The direction of the arrowhead of the pointer 62 further signifies that its associated indicator 58 has been moving closer (a “positive” movement) to the direction of the “Fully Met” level on the scale 54. On the other hand, in case of the reference pointer 63 in FIG. 6, the most recent position of its associated indicator 59, as shown in FIG. 6, is away from the desired completion level (i.e., the “Fully Met” level), signifying a “negative” movement in the progress of the associated task (not shown in the window 53) from the immediately preceding level on the scale 55. Therefore, in that case, the reference pointer 63 is pointed leftward to indicate the direction of the most recent progress of the task, and is also placed at a (higher) location adjacent the scale 55 that was the location of the indicator 59 before its most recent placement along the scale 55 as shown in FIG. 6.

It is noted here that the slider or indicator 58-60 may be moved, for example, manually by a user (e.g., a nurse or another patient administrator in a hospital) to indicate the most recent progress of a task (e.g., a patient condition or patient recovery monitoring). The user may use a computer mouse (or a designated key on a computer keypad, or other pointing device) to select the appropriate indicator to be moved and then click and hold the mouse pointer while “dragging” or moving the indicator along the respective scale to the desired position. That new position is then the “most recent” position of the indicator, whereas the position prior to the “dragging” action is the position where the associated reference pointer may be displayed adjacent to the respective scale. Thus, the sliding scoring mechanism allows a user to slide, for example, a bar to the desired “score” or progress level on the respective scale, whereas the associated bidirectional reference pointer provides a visual cue as to whether the most recent indicator movement is an upward or downward progress of the status of the task. In tasks or activities where quantitative or absolute numerical values are to be measured (e.g., a temperature measurement in a power plant) as opposed to qualitative observations (e.g., progress of a patient's condition), the reference pointer may provide a visual cue as to whether the most recent “score” or reading of a parameter to be observed (e.g., temperature) is an increase or decrease from the previous reading.

FIG. 7 shows the screenshot of FIG. 6 with a task-specific overlayed window 68 displaying textual information about the most recent progress status for the task. In the embodiment of FIG. 7, a user has selected to move the indicator 58 along the scale 54 by clicking and holding a computer mouse pointer on the slide bar 58. It is observed here that the term “user” is used broadly herein to include a human as well as a software (e.g., in an automated task monitoring environment) operating the corresponding computer terminal. In the embodiment of FIG. 7, the goal scoring software 32 receives the mouse pointer input and, in turn, “converts” or “represents” the displayed bar-like slider mechanism 58 as a bidirectional arrow 66 with a divider or marker 67 displayed at the center of the arrow 66 to indicate the location on the scale 54 where the indicator 58 would be positioned once the user removes the “hold” of the mouse button used to “drag” the indicator 58 along the scale 54. In one embodiment, the arrow 66 may be displayed automatically (i.e., without a mouse click) when the user just points a mouse pointer at the indicator 58. In the embodiment of FIG. 7, the scale 54 may be displayed on hover or in an “embossed” form (as opposed to the “sunk in” or “indented” display in FIG. 6) during movement of the associated indicator 58. Thereafter, the scale 54 may return to its original view shown in FIG. 6. In addition to these display changes, the task status monitor program 32 may also display an overlayed window 68 adjacent to the indicator (bidirectional arrow 66) being moved along the scale 54. The window 68 may be displayed as an overlayed or in a hover position over the application workspace 52 beneath the scale 54 as shown in FIG. 7. The exact location of display for the window 68 may change depending on the movement of the arrow 66 along the scale 54. In one embodiment, the location of display for the window 68 may move synchronously with the movement of the arrow 66 within the display space available in the application window 52. In another embodiment, however, the display location of the window 68 may remain static or unchanged throughout the movement of the arrow indicator 66. Other items displayed in FIG. 7 (e.g., the reference pointer 62, or the window 53, etc.) are similar to those shown in FIG. 6 and, hence, no additional discussion of those items is provided hereinbelow. As noted before, the goal scorer 32 may be configured to require a click and hold of a mouse pointer to display the window 68, or, alternatively, in one embodiment, the goal scorer 32 may be configured to display the window 68 automatically when the mouse pointer is at the location of the underlying indicator 58 (i.e., without requiring the click and hold of the mouse pointer). Other display configurations may be suitably devised.

In one embodiment, the window 68 displays textual information related to a first progress score associated with the most recent placement of the arrow indicator 66 along the scale 54, a second progress score associated with the immediately preceding position of the indicator 66 along the scale 54 prior to the current movement of the indicator 66, and an indication whether the first score is a positive or negative movement from the second score. As noted before, the score may be a numerical representation of a qualitative parameter (e.g., a patient's condition) or a quantitative value (e.g., a temperature measurement) to be monitored. For example, in the illustration in FIG. 7, the overlayed window 68 shows the first score to be 25%, the second score to be 10%, and the textual indication points out that the most recent score (25%) is “up from” (indicating a positive or “more desirable” movement) the immediate past score of 10%. In another case, the text in the window 68 may indicate a “down from” or negative (or “less desirable”) movement (not shown) from the previous score. The goal scorer software 32 may be configured to store information or data related to the most recent as well as the next most recent (or immediately previous) position of the indicator 58 so as to provide the corresponding score and movement information in the window 68 in the manner illustrated, for example, in FIGS. 7-8.

The textual display in the window 68 further provides guidance to the user that the most recent placement of the indicator 66 would correspond to the completion of 25% of the target level of 100% (as represented by the “Fully Met” status marked on the scale 54). The textual information with relevant numerical values (acting as progress markers for a task whose status is being monitored) allows the user to visually comprehend the progress level of the task. Whenever a user provides a new input about the progress of the task (e.g., by moving the indicator 58 leftward or rightward along the scale 54), the text display in the window 68 may clearly indicate to the user the results of the user's action as well as the current status of the task progress. If a user mistakenly moves the arrow 66 to a wrong position along the scale 54, the display in the window 68 will alert the user of that fact when the user reads the content of the window to find out that the content of the window does not reflect the correct status that the user wishes to input at that time. Therefore, the clear, legible manner of display of the task progress-related text in the window 68 provides an efficient, visual guidance to the user inputting the progress data through leftward or rightward sliding of the bi-directional arrow 66. The display of a bidirectional arrow 66 further alerts the user to the horizontal (leftward or rightward) nature of the movement of the slider bar 58 along the scale 54.

FIG. 8 depicts another screenshot of FIG. 6 with a different content in the task-specific overlayed window 68 shown in FIG. 7. In the embodiment of FIG. 8, the user has observed an “upward” or “positive” progress for the task associated with the scale 54 and, hence, moved the indicator arrow 66 to another location (representing completion of 60% of the task) along the scale 54 that is rightward from the previous 25% representative location in FIG. 7. As noted before, the goal scoring software 32 would display this most-recent task completion score of 60% along with the next most-recent score (now the 25% score as opposed to the 10% score as was the case in FIG. 7) in the text of the display window 68 as can be seen from the screenshot in FIG. 8. An indication that the new progress score is “up from” the immediately previous progress reporting is also displayed in the window 68 as shown in FIG. 8. Every time a user moves the arrow 66, the text in the display window 68 would change to reflect the representative score associated with the most-recent arrow position along the scale 54 and the nature of the movement with respect to the immediately prior position of the arrow 66. Furthermore, as discussed hereinbefore, the location of the associated reference pointer (here, the pointer 62) may also change to the “new” position as can be seen from a comparison of the locations of the reference pointer 62 in FIGS. 7 and 8. In FIG. 7, the reference pointer 62 is displayed adjacent to a scale position (of the indicator 58) that is representative of completion of 10% of the task, whereas in FIG. 8, the pointer 62 is displayed at a location that represents completion of 25% of the task in the context of the scale 54. Thus, the progress of the associated task can be clearly and visually efficiently monitored without any clutter or distractions using the overlayed window format along with the reference pointer-based display mechanism.

FIG. 9 illustrates an exemplary screenshot that partially depicts scale and indicator based electronic score displays for a patient's plan of care in a hospital environment. The plan of care may be displayed (e.g., by appropriate content display program 30) on a nurse's computer terminal (or any other similar video monitor, including a hand-held display device) to assist the nurse in performing the desired treatment for the patient. The active workplace in the screenshot is indicated by the reference numeral “70” in FIG. 9. The nurse may select one or more fields to view from the horizontal row 72 displaying the fields to be selected (e.g., by clicking a mouse pointer at the field location in the row 72). It is noted that a patient problem may have one or more “goals” associated with it. Each goal may be considered as an expected result that a nurse wants to see when the nurse performs a number of “interventions” associated with the selected goal. For example, in the display 70 in FIG. 9, the operator (e.g., a nurse or other patient administrator) of the computer terminal has selected to display information contents associated with the “Deficient Knowledge” problem of the “Chest Pain” standard of care. As a result, the problem as well as its associated goals and interventions are displayed (e.g., by appropriate content display program 30) on the active workspace 70, followed by textual information related to other problems identified in the “Chest Pain” standard of care. The displayed content may be useful to the patient administrator in selecting appropriate actions to take to achieve the relevant goals. In the embodiment of FIG. 9, each goal is displayed in a “sunk-in” sub-window similar to the task data window 53 in FIGS. 6-8. Two such sub-windows 74 and 78 are labeled in FIG. 9 for simplicity and ease of illustration. It is seen from FIG. 9 that the progress of the selected goal may be monitored using the associated goal scoring scales that may be displayed using a goal scorer program (e.g., similar to the goal scorer 32) adapted for use in a hospital environment. For example, in case of the goal displayed in the window 74, the active workspace also partially displays associated goal scoring scale 75 and indicator 76. Similarly, the scale 79 and indicator 80 are also marked in FIG. 9 for the goal displayed in the window 78. Additional goal-specific scales and indicators may be provided as shown in the partial displays in FIG. 9. The progress of a selected goal may be “recorded” and monitored by the patient administrator using the scale and indicator based goal scoring methodology discussed hereinbefore with reference to FIGS. 6-8 and, hence, additional operational details for the embodiment of FIG. 9 is not provided herein.

It is noted here that the goal scoring software 32 may be implemented as software code to be executed by a processor (not shown) (e.g., a processor in the content display terminal 36 in FIG. 4) using any suitable computer language such as, for example, Java, Ada, Visual Basic, C, C# or C++ using, for example, conventional or object-oriented techniques. The software code may be stored as a single program module or a set of program modules performing different functions. The program modules may be stored on a computer-readable medium, such as a random access memory (RAM), a read only memory (ROM), a magnetic medium such as a hard-drive or a floppy disk (e.g., the floppy disk 38 in FIG. 4), or an optical medium such as a CD-ROM (e.g., the CD ROM 40 in FIG. 4). The software code for the goal scorer 32 may contain a series of instructions or commands provided to accomplish the positioning and display of scale and indicator based goal scoring methodology discussed hereinbefore with reference to the embodiments in FIGS. 6-8. For example, a first program module (not shown) of the goal scorer 32 may interact with the content display program 30 and may be configured to display a scale and an indicator at a predetermined location (e.g., on the display monitor of the terminal 36) along with the associated task related data or information displayed, for example, by the content display program 30. A second program module (not shown) may monitor status of an external input (e.g., from a user's computer mouse) and responsively position the indicator along the scale as desired by the user. A third program module may store two most recent “scores” for display in the display window (e.g., the window 68 in FIGS. 7-8) associated with each indicator position along the scale. Additional program modules may also be provided to accomplish various other tasks contemplated by the designer of the goal scoring software 32 to accomplish the task progress score or reading display methodology discussed hereinbefore with reference to FIGS. 5-8.

As noted before, the score display methodology according to one embodiment of the present disclosure may be adapted to be used in a variety of applications where progress status of a task (e.g., a patient's condition in a hospital) or reading of a parameter (e.g., a periodic temperature reading in a power plant) may assume a range of values and are to be monitored over a period of time. Furthermore, as discussed hereinbefore, the goal scoring software for each such application may be adapted to suit the needs of the application. Thus, for example, the orientation and style of display for the scale and indicator based arrangement illustrated in FIGS. 6-9 may be modified to suit the requirements of an application at hand. However, regardless of such modifications or changes, the goal scoring methodology according to one embodiment of the present disclosure provides a user-friendly display of progress status of a task to be monitored by the user. The task progress display according to the teachings of the present disclosure, as can be seen from the exemplary screenshots in FIGS. 6-9, provides significantly more information on the progress of a task in an intuitive and visually efficient manner without any intrusive or distracting clutter. This allows the user to glean the requisite task status information very quickly without losing attention to other visual details on the screen.

The foregoing describes an electronic progress scoring mechanism or indicator that visually informs the user of how much of a task is complete and what is the nature or direction of the progress of task completion (positive or negative). A goal scoring software provides a scale and indicator based display for a task whose progress is to be monitored. The indicator can slide over the scale to indicate the most recent status of the task. A bi-directional reference pointer is displayed adjacent to the scale to provide a visual cue as to whether the most recent status indicates an upward (“better” or “more desirable”) or downward (“worse” or “less desirable”) progress from the immediately preceding status. An overlayed display window may also be provided adjacent to the sliding indicator to textually display the two most recent scores of progress and the relationship between them (i.e., whether there is a positive or negative movement from an earlier score to the most recent score). The task status indicator display can provide significantly more information on the progress of a task in an intuitive, but non-intrusive (non-distracting) manner.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

1. An electronic display, comprising:
a scale icon;
an indicator positioned on said scale icon for indicating a most recent score for a task associated with said scale icon; and
a reference pointer displayed proximate to said scale icon for providing a visual cue as to whether said most recent score is an upward or downward movement from a previous score for said task.

2. The electronic display of claim 1, wherein said reference pointer is a bidirectional pointer that is displayed in a first direction when said most recent score indicates said upward movement and in a second direction when said most recent score indicates said downward movement.

3. The electronic display of claim 2, wherein said reference pointer is displayed in a first color in said first direction and in a second color in said second direction.

4. The electronic display of claim 1, wherein said indicator comprises a representation of a slider movably displayed on a rectangular scale icon.

5. The electronic display of claim 1, wherein said indicator comprises a representation of a needle movably displayed on a circular scale icon.

6. The electronic display of claim 1, wherein said reference pointer is displayed proximate to said scale icon at substantially the same position as the position of said indicator on said scale icon for said previous score.

7. The electronic display of claim 1, wherein said reference pointer is displayed below said scale icon.

8. An electronic display, comprising:
a scale icon;
an indicator positioned on said scale icon for indicating a most recent score for a task associated with said scale icon when said indicator is positioned at a first location along said scale icon; and
a display window positioned proximate to said scale icon for providing a textual display of at least one of the following:
a first score associated with said first location;
a second score associated with a second location of said indicator for a score immediately preceding said most recent score; and
an indication of whether said first score is an increase or decrease from said second score.

9. The electronic display of claim 8, wherein said indicator comprises a representation of a slider movably displayed on a rectangular scale icon.

10. The electronic display of claim 8, wherein said indicator comprises a representation of a needle movably displayed on a circular scale icon.

11. The electronic display of claim 8, wherein said display window is displayed below said indicator.

12. The electronic display of claim 8, wherein said scale icon is configured to be displayed in a hovering manner upon occurrence of one of the following:
display of said display window;
when a computer mouse pointer is clicked and held on said indicator; and
when a computer mouse pointer is placed on said indicator.

13. The electronic display of claim 8, further comprising:
a bidirectional pointer that is displayed in a first direction when said first score indicates an upward movement from said second score and in a second direction when said first score indicates a downward movement from said second score.

14. The electronic display of claim 13, wherein said pointer is displayed in a first color in said first direction and in a second color in said second direction.

15. A data storage medium containing program code which, upon execution by a processor in a computing system, causes said processor to perform the steps of claim 35.

16. The medium of claim 15, wherein said display of a reference pointer comprises displaying said reference pointer in a first direction when said most recent score indicates said upward movement and in a second direction when said most recent score indicates said downward movement.

17. The medium of claim 16, wherein said display of a reference pointer comprises displaying said reference pointer in a first color in said first direction and in a second color in said second direction.

18. The medium of claim 15, wherein said displaying an indicator comprises displaying a representation of a slider movably displayed on a rectangular scale icon.

19. The medium of claim 15, wherein said displaying an indicator comprises displaying a representation of a needle movably displayed on a circular scale icon.

20. The medium of claim 15, wherein said displaying a reference pointer comprises displaying a reference pointer proximate to said scale icon at substantially the same position as the position of said indicator on said scale icon for said previous score.

21. The medium of claim 15, wherein said displaying a reference pointer comprises displaying said reference pointer below said scale icon.

22. A data storage medium containing program code which, upon execution by a processor in a computing system, causes said processor to perform the steps of claim 36.

23. The medium of claim 22, wherein said displaying an indicator comprises displaying a representation of a slider movably displayed on a rectangular scale icon.

24. The medium of claim 22, wherein said displaying an indicator comprises displaying a representation of a needle movably displayed on a circular scale icon.

25. The medium of claim 22, wherein said displaying a window comprises displaying a window below said indicator.

26. The medium of claim 22, wherein said displaying a scale icon is configured to be displayed in a hovering manner upon occurrence of one of the following:
display of said display window;
when a computer mouse pointer is clicked and held on said indicator; and
when a computer mouse pointer is placed on said indicator.

27. The medium of claim 22, further comprising:
displaying a bidirectional pointer in a first direction when said first score indicates an upward movement from said second score and in a second direction when said first score indicates a downward movement from said second score.

28. The medium of claim 27, wherein said displaying a pointer comprises displaying a pointer in a first color in said first direction and in a second color in said second direction.

29. A processor in a computing system, which, upon being programmed, is configured to perform the steps of claim 35.

30. A processor in a computing system, which, upon being programmed, is configured to perform the steps of claim 36.

31. A system, comprising:
a computing unit containing a processor configured to execute program code;
an electronic display operatively connected to said computing unit to display thereon information supplied thereto by said processor; and
a data storage medium operatively connected to said computing unit and containing program code, which, upon execution by said processor, causes said processor to perform the steps of claim 35.

32. A system, comprising:
a computing unit containing a processor configured to execute program code;
an electronic display operatively connected to said computing unit to display thereon information supplied thereto by said processor; and
a data storage medium operatively connected to said computing unit and containing program code, which, upon execution by said processor, causes said processor to perform the steps of claim 36.

33. A task status monitor for displaying progress of a task on an electronic display, said monitor comprising:
means for displaying a scale icon;
means for displaying an indicator on said scale icon for indicating a most recent score for a task associated with said scale icon; and
means for displaying a reference pointer proximate to said scale icon for providing a visual cue as to whether said most recent score is an upward or downward movement from a previous score for said task.

34. The task status monitor of claim 33, further comprising:
means for displaying a window adjacent to said indicator to provide a textual display of at least one of the following:
a first score associated with a first location of said indicator along said scale icon to indicate said most recent score;
a second score associated with a second location of said indicator to indicate said previous score, wherein said previous score immediately precedes said most recent score; and
an indication of whether said first score is an increase or decrease from said second score.

35. A method, comprising:
displaying a scale icon;
displaying an indicator positioned on said scale icon for indicating a most recent score for a task associated with said scale icon; and
displaying a reference pointer displayed proximate to said scale icon for providing a visual cue as to whether said most recent score is an upward or downward movement from a previous score for said task.

36. A method, comprising:
displaying a scale icon;
displaying an indicator positioned on said scale icon for indicating a most recent score for a task associated with said scale icon when said indicator is positioned at a first location along said scale icon; and
providing a display window positioned proximate to said scale icon for providing a textual display of at least one of the following: a first score associated with said first location;
a second score associated with a second location of said indicator for a score immediately preceding said most recent score; and an indication of whether said first score is an increase or decrease from said second score.

37. A system, comprising:
a client computer connected to a communication network; and
a host computer in communication with the client computer and connected to said communication network, wherein said host computer is configured to perform the following: receive information related to a progress of a task;
provide an electronic display of the progress of the task on a first computer monitor associated with a first computer, wherein said electronic display comprises: a scale icon; an indicator positioned on said scale icon for indicating a most recent score for a task associated with said scale icon; and a reference pointer displayed proximate to said scale icon for providing a visual cue as to whether said most recent score is an upward or downward movement from a previous score for said task; and
send contents of said electronic display to said client computer over said communication network to be displayed in a form that is substantially similar to said electronic display on a second computer monitor associated with said client computer.

38. A system, comprising:
a client computer connected to a communication network; and
a host computer in communication with the client computer and connected to said communication network, wherein said host computer is configured to perform the following: receive information related to a progress of a task; and
provide an electronic display of the progress of the task on a first computer monitor associated with a first computer, wherein said electronic display comprises: a scale icon; an indicator positioned on said scale icon for indicating a most recent score for a task associated with said scale icon when said indicator is positioned at a first location along said scale icon; and a display window positioned proximate to said scale icon for providing a textual display of at least one of the following:
a first score associated with said first location;
a second score associated with a second location of said indicator for a score immediately preceding said most recent score; and
an indication of whether said first score is an increase or decrease from said second score; and
send contents of said electronic display to said client computer over said communication network to be displayed in a form that is substantially similar to said electronic display on a second computer monitor associated with said client computer.

39. The method of claim 35 further comprising:
receiving information related to a progress of a task; and
providing an electronic display of the progress of the task on a first computer monitor associated with a first computer, wherein providing the electronic display comprises said steps of displaying a scale icon, displaying an indicator and displaying a reference pointer.

40. The method of claim 36 further comprising:
receiving information related to a progress of a task; and
providing an electronic display of the progress of the task on a first computer monitor associated with a first computer, wherein providing the electronic display comprises said steps of displaying a scale icon, displaying an indicator and providing a display window.
